(19) United States
(12) Patent Application Publication
(10) Pub. No.: US 2013/0333027 A1
(43) Pub. Date: Dec. 12, 2013

(54) DYNAMIC RIGHTS ASSIGNMENT

(71) Applicants: Christopher L. SELLERS, Missoula, MT (US); Benjamin Kyrk ULLMAN, Chandler, AZ (US)

(72) Inventors: Christopher L. SELLERS, Missoula, MT (US); Benjamin Kyrk ULLMAN, Chandler, AZ (US)

(73) Assignee: FORTY1 TECHNOLOGIES INC., Dallas, TX (US)

(21) Appl. No.: 13/492,774

(22) Filed: Jun. 8, 2012

(51) Int. Cl. G06F 21/00

(52) U.S. Cl. 726/22

(57) ABSTRACT

In a first embodiment of the present invention, a method for blocking malicious software in an operating system, comprising: receiving a command to open a file; determining a file association for the file, wherein the file association points to a dynamic rights assignment module; evaluating what process issued the command to open the file; determining if the process that issued the command to open the file is known to be safe; when it is determined that the process that issued the command to open the file is not known to be safe, prompting a user whether to run in protected mode; when the user indicates that protected mode should be run, creating a temporary user of the operating system; and running a program associated with the file association for the file, as the temporary user.

### BACKGROUND OF THE INVENTION

Malicious computer software (e.g., Trojan horses, Worms, Spyware, Viruses, etc.) are a known and constant threat to businesses and individuals. There are various methods of infection, propagation, and concealment of such malware. Indeed, for every solution that anti-virus manufacturers come up with, malware creators find two workarounds.

Various antivirus programs exist in the market today. The goal of such software is to prevent infection and/or remove the infection once it is detected. These programs run by utilizing a database of known malware signatures. The antivirus manufacturer periodically updates the database to identify new malware. A user installs the antivirus software on his or her computer, and then the program constantly runs in the background of the computer system. This has a number of drawbacks. First of all, because the antivirus program is continuously running in the background, it eats up valuable processing time and other resources, slowing down the system as a whole. Second of all, it requires updates in order to be effective, updates which take up user time and/or bandwidth to download. Third of all, given the volume of malware in existence, the signature databases have now grown to be very large, which takes up space on the computer system as well as means that even more processing power is needed to scan through the entire database of signatures. Such problems are only going to get worse, as the number of malicious programs is always increasing, never decreasing.

What is needed is a solution that does not require background operation, constant updates, or an ever-increasing number of signatures in a database.

### SUMMARY OF THE INVENTION

In a first embodiment of the present invention, a method for blocking malicious software in an operating system, comprising: receiving a command to open a file; determining a file association for the file, wherein the file association points to a dynamic rights assignment module; evaluating what process issued the command to open the file; determining if the process that issued the command to open the file is known to be safe; when it is determined that the process that issued the command to open the file is not known to be safe, prompting a user whether to run in protected mode; when the user indicates that protected mode should be run, creating a temporary user of the operating system; and running a program associated with the file association for the file, as the temporary user.

In a second embodiment of the present invention, a computer system is provided comprising: a processor; an operating system, wherein the operating system contains a registry having file associations; a user account module; a dynamic rights assignment module configured to; evaluate what process issued a command to open a file, wherein the command to open the file triggered the registry to call the dynamic rights assignment module; determine if the process that issued the command to open the file is known to be safe; when it is determined that the process that issued the command to open the file is not known to be safe, prompting a user whether to run in protected mode; and when the user indicates that protected mode should be run, issuing a call to the user account module to create a temporary user to run a program associated with a file association for the file.

In a third embodiment of the present invention, a program storage device readable by a machine tangibly embodying a program of instructions executable by the machine to perform a method for blocking malicious software in an operating system is provided, the method comprising: receiving a command to open a file; determining a file association for the file, wherein the file association points to a dynamic rights assignment module; evaluating what process issued the command to open the file; determining if the process that issued the command to open the file is known to be safe; when it is determined that the process that issued the command to open the file is not known to be safe, prompting a user whether to run in protected mode; when the user indicates that protected mode should be run, creating a temporary user of the operating system; and running a program associated with the file association for the file, as the temporary user.

### BRIEF DESCRIPTION OF THE DRAWINGS

FIG. 1 is a flow diagram illustrating a method for blocking malicious software in accordance with an embodiment of the present invention.

FIG. 2 is a flow diagram illustrating another method for blocking malicious software in accordance with an embodiment of the present invention.

FIG. 3 is a flow diagram illustrating a method for blocking malicious software in accordance with an alternative embodiment of the present invention.

FIGS. 4-12 are screen captures illustrating a case study of the effects and effectiveness of a malware-blocking system in accordance with an embodiment of the present invention.

### DETAILED DESCRIPTION

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

In an embodiment of the present invention, malicious programs are prevented from accessing files or services on a computer system by limiting access rights unless the calling process is known to be safe. File associations in the operating system are altered to point to a dynamic rights assignment module instead of a usual program that the file association would normally point to. The dynamic rights assignment module then, when a particular file type is accessed, determines if the calling process is known to be safe, and if not, prompts the user as to whether to run in a protected mode. If so, then a temporary user is created and the usual program is run as the temporary user instead of as the actual user. This allows the system to easily identify changes made using the process and block or reverse those changes.

File associations in an operating system define programs which are to be automatically run when a particular file type is accessed. Oftentimes this can be related to a file's extension (e.g., .doc, .xls, etc.) but not necessarily. The file association can, for example, make is so that Microsoft Word is automatically opened when a .doc file is accessed. The file associations are typically stored in a registry of the operating system.

In the present invention, the file associations for key file types of an operating system are altered to point to a DRA module instead of the programs they normally would point to. A key file type may be defined as any file type of the operating system that has the potential to be exploited by malware. Examples include file types of programs that allow programs to run automatically, file types of programs that work as “add-ons” for other programs (such as Internet Explorer and a toolbar, as well as file management apps that add menus to the right click context), file types associated with Layered Service Providers (LSPs) that add network functionality to the TCP/IP stack, and file types associated with system drivers.

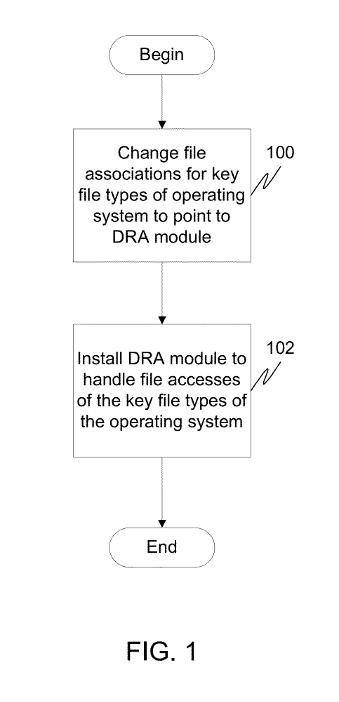

FIG. 1 is a flow diagram illustrating a method for blocking malicious software in accordance with an embodiment of the present invention. The method depicted is performed at installation time. In other words, the steps involved are all performed in order to set the system up to a state where blocking of malicious software occurs. In one embodiment, these steps are all undertaken at a single computer, such as a desktop or laptop computer. In other embodiments, some of the steps may be performed remotely, such as by an administrator at a server with other steps being performed on local client computers.

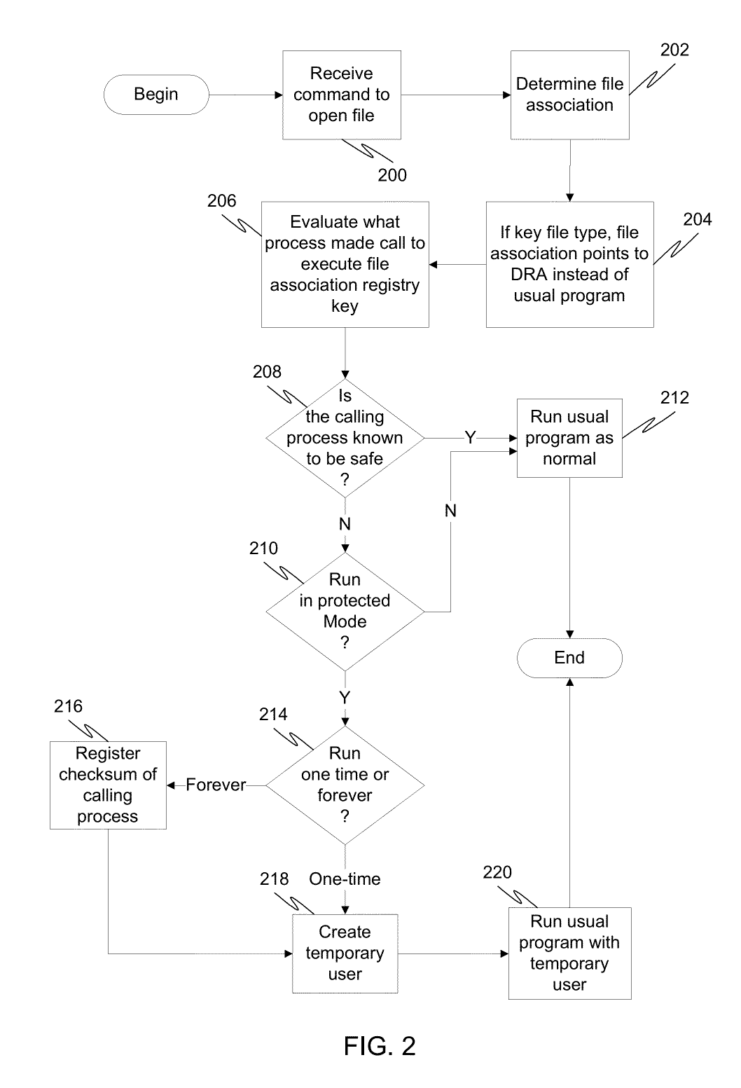

At 100, file associations for key file types of the operating system are changed to point to the DRA module. This may include modifying the registry. At 102, the DRA module is installed, which will handle the file accesses of the key file types of the operating system. The DRA module may be designed to perform many of the tasks described in FIG. 2 below.

FIG. 2 is a flow diagram illustrating another method for blocking malicious software in accordance with an embodiment of the present invention. The method depicted is performed at run time. In other words, the steps involved are all performed when a user is running the operating system in a manner that he wished to block malicious programs.

At 200, a command to open a file is received. At 202, the file association of the file is determined. At 204, if the file association is a key file type, then the file association, when followed, will point to a dynamic rights assignment module rather than the usual program. This is because during initialization, the system will update key file type file associations to point to the dynamic rights assignment module. At 206, the system evaluates what process made the call to execute the file association registry key. At 208, it is determined if the calling process is known to be safe. If not, then at 210 it is determined if the system should run in protected mode. If not, or if at 208 it is determined that the calling process is known to be safe, then at 212 the usual program is run as normal. In other words, if the calling process is known to be safe, DRA can largely be ignored. If at 210 it was determined that the command was going to be run in protected mode, then at 214 it is determined if the command is going to be run one time or forever using these security settings. If forever, then at 216 the checksum of the calling process can be registered. After that, or if at 214 it is determined to run using only a single-time using these security settings, then at 218 a temporary user is created. Most operating systems allow for user accounts. A user account defines the actions a user can perform in the operating system. On a stand-alone computer or a computer that is a member of a workgroup, a user account establishes the privileges assigned to each user. On a computer that is part of a network domain, a user must be a member of at least one group. The permissions and rights granted to a group are assigned to its members. Whatever type of computer system the user account is set up for, the rights and permissions may include security rights, which involve the right to access certain files, processes, and services of the computer system.

The present invention utilizes this user account mechanism to prevent malicious software from gaining control over an operating system by creating a temporary user, who will have only limited rights. At 220, the usual program is then run using the temporary user.

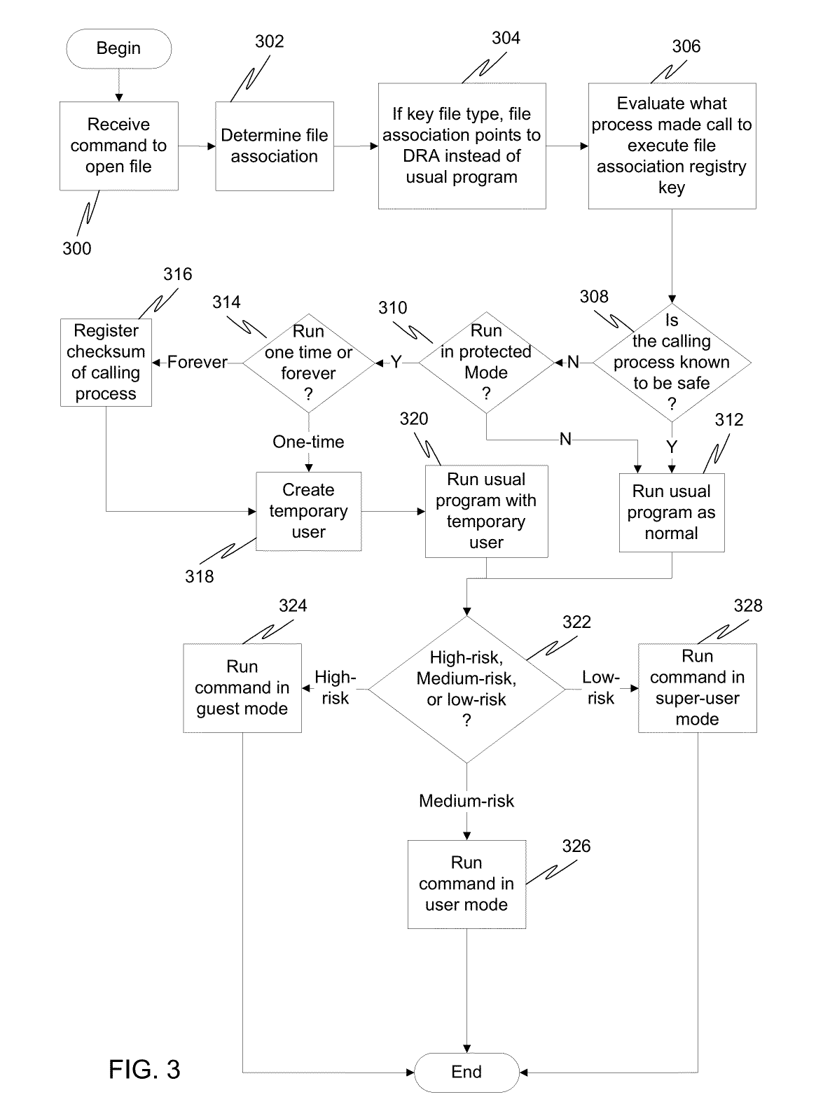

Notably, the run-time method of FIG. 2 may actually be run in the context of a larger method for blocking malicious software involving blocking access to key sections of an operating system. FIG. 3 is a flow diagram illustrating a method for blocking malicious software in accordance with this alternative embodiment of the present invention. At 300, a command to open a file is received. At 302, the file association of the file is determined. At 304, if the file association is a key file type, then the file association, when followed, will point to a dynamic rights assignment module rather than the usual program. This is because during initialization, the system will update key file type file associations to point to the dynamic rights assignment module. At 306, the system evaluates what process made the call to execute the file association registry key. At 308, it is determined if the calling process is known to be safe. If not, then at 310 it is determined if the system should run in protected mode. If not, or if at 308 it is determined that the calling process is known to be safe, then at 312 the usual program is run as normal. In other words, if the calling process is known to be safe, DRA can largely be ignored. If at 310 it was determined that the command was going to be run in protected mode, then at 314 it is determined if the command is going to be run one time or forever using these security settings. If forever, then at 316 the checksum of the calling process can be registered. After that, or if at 314 it is determined to run using only a single-time using these security settings, then at 318 a temporary user is created. At 320, the usual program is then run using the temporary user.

At 322, the user is then prompted to inquire how to run the command, i.e. what level of risk is assumed for this command. In one example, the user can select between “high-risk”, “medium-risk”, and “low-risk”. The effect of the user's selection is depicted as 324, 326, and 328. If the user selected “high-risk”, then the command is run in guest mode at 324. In guest mode, the command is essentially not allowed to access any part of the operating system, not even to do very basic things like save files to a desktop or server. If the user selected “medium-risk”, then at 326 the command is run in user mode, which allows the command to perform generally non-threatening tasks, such as saving files to the desktop or server. If the user selected “low-risk”, then the command is run in super-user mode at 328, where the command is allowed full access rights. As such, the user is generally cautioned to be very careful in allowing the command to run in “low-risk” mode.

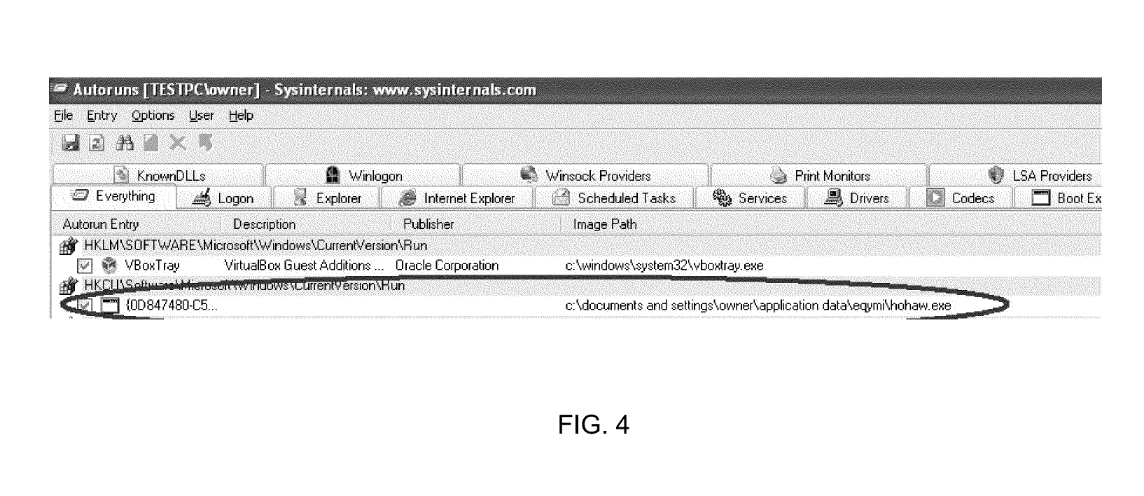

FIGS. 4-12 are screen captures illustrating a case study of the effects and effectiveness of a malware-blocking system in accordance with an embodiment of the present invention. In this case study, it is assumed a virus named “Zeus” exists and that Zeus' primary objective is stealing credit card, banking, and online account information.

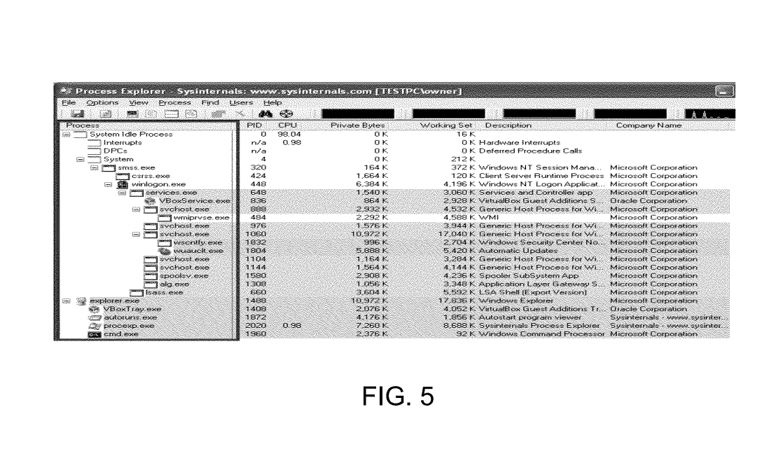

With no protection (anti-virus or other malware blocker, such as an implementation of the present invention), the machine is instantly infected. The machine's registry is compromised, and all user accounts are infected as well. Zeus is in fact configured to run each time the machine starts, as can be seen in FIG. 4, showing the infected executable set to run automatically on each boot. Additionally, as seen in FIG. 5, there is no indication that the infection has taken place, with the exception of a small slow down in running Internet Explorer when the virus was installing. No trace of the virus can be found by viewing running programs.

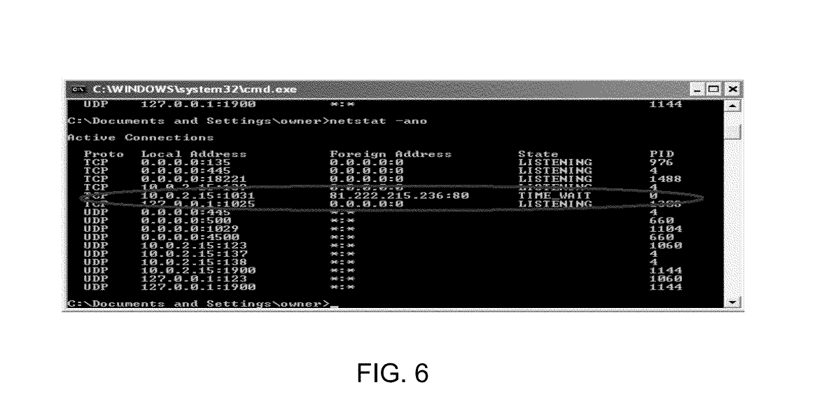

Furthermore, as can be seen in FIG. 6, the virus attempts to covertly connect back to a “botmaster”, or person controlling the infected machines. This is done silently, in the background, using a system process (PID 0) to prevent detection.

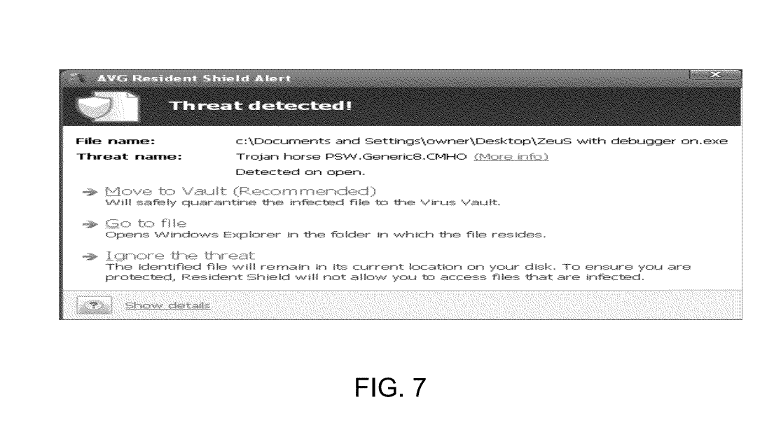

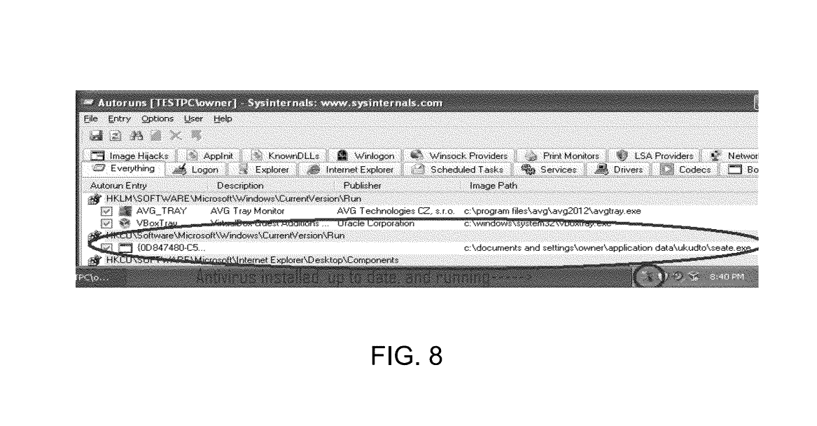

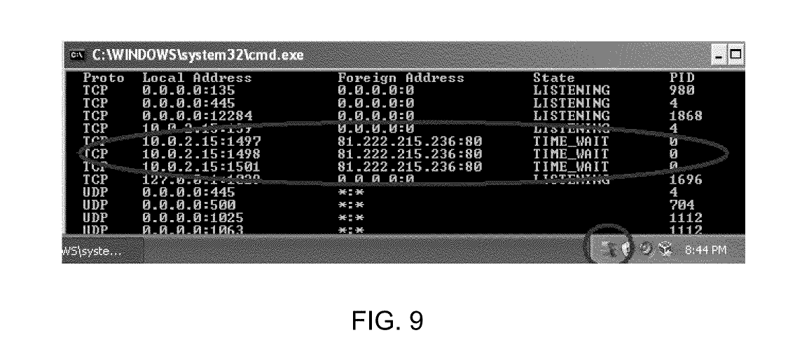

FIGS. 7-9 depict screen captures of how Zeus is handled by a traditional anti-virus software. In FIG. 7, the virus is detected on manual execution of the anti-virus software. While detected when running the anti-virus program itself, or when running the virus executable directly from a desktop via a double click, the virus is in fact not detected when installed via “drive-by-download” and the machine becomes infected just as if there was no antivirus program at all. In FIG. 8, the virus is set to run automatically. In FIG. 9, the virus still attempts to connect back to its botmaster, even with the Antivirus program working.

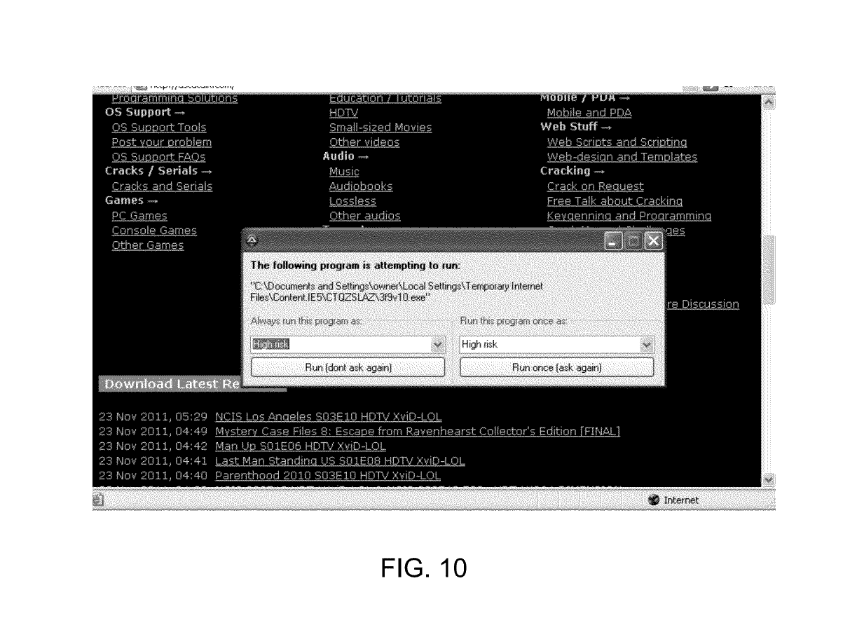

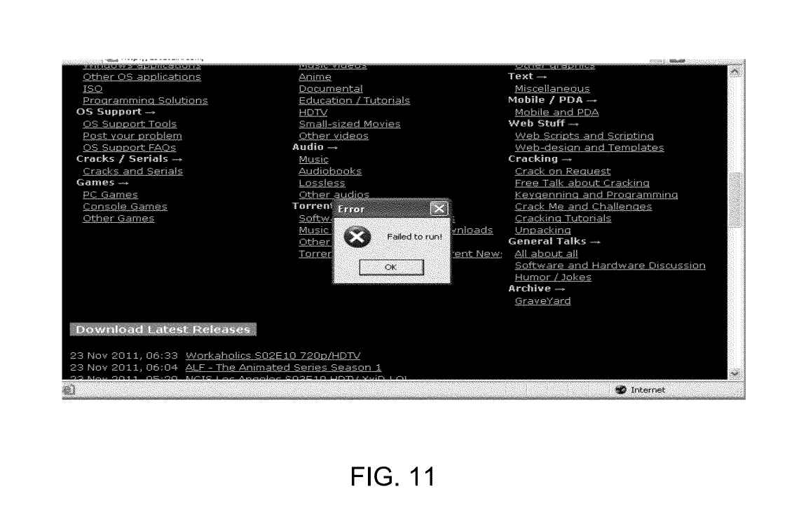

FIGS. 10-14 depict screen captures of how Zeus is handled by an embodiment of the present invention. In FIG. 10, the drive-by-download of the virus is automatically detected and classified as being high-risk. The user is presented with options to classify the process as such, and whether to run the process forever or just once using the selected risk settings. Since the virus is classified as high-risk, it becomes impossible for the virus to execute. Thus, in FIG. 11, the virus crashes upon execution in protected mode.

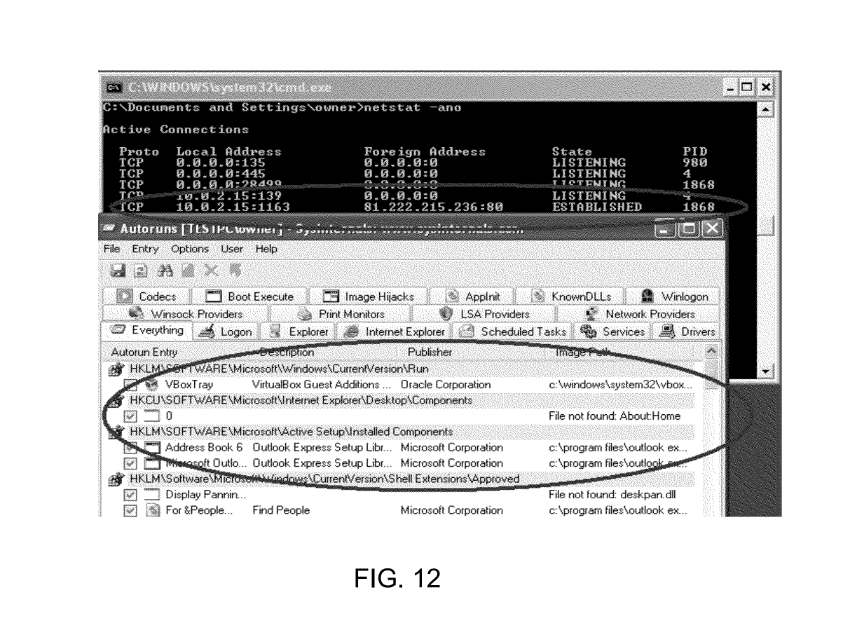

If the virus is run in unprotected mode, the virus is able to run, but is still not able to fully infect the machine. As can be seen in FIG. 12, an attempt to connect to a malicious botmaster is made, but it is not running as a system (PID 0). Additionally, no infected auto starting programs can be installed. Thus, while the virus is live and able to connect, it is not actually able to infect. Therefore, when the machine is rebooted, the virus is gone.

As will be appreciated to one of ordinary skill in the art, the aforementioned example architectures can be implemented in many ways, such as program instructions for execution by a processor, as software modules, microcode, as computer program product on computer readable media, as logic circuits, as application specific integrated circuits, as firmware, as consumer electronic device, etc. and may utilize wireless devices, wireless transmitters/receivers, and other portions of wireless networks. Furthermore, embodiment of the disclosed method and system for displaying multimedia content on multiple electronic display screens can take the form of an entirely hardware embodiment, an entirely software embodiment, or an embodiment containing both software and hardware elements.

The term “computer readable medium” is used generally to refer to media such as main memory, secondary memory, removable storage, hard disks, flash memory, disk drive memory, CD-ROM and other forms of persistent memory. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

Although only a few embodiments of the invention have been described in detail, it should be appreciated that the invention may be implemented in many other forms without departing from the spirit or scope of the invention. Therefore, the present embodiments should be considered illustrative and not restrictive and the invention is not to be limited to the details given herein, but may be modified within the scope and equivalents of the appended claims.

What is claimed is:

1. A method for blocking malicious software in an operating system, comprising:
receiving a command to open a file;
determining a file association for the file, wherein the file association points to a dynamic rights assignment module;
evaluating what process issued the command to open the file;
determining if the process that issued the command to open the file is known to be safe;
when it is determined that the process that issued the command to open the file is not known to be safe, prompting a user whether to run in protected mode;
when the user indicates that protected mode should be run, creating a temporary user of the operating system; and
running a program associated with the file association for the file, as the temporary user.

2. The method of claim 1, further comprising:
prompting the user as to whether to run the command one time or forever using the protected mode; and
when the user indicates that the command should be run forever using the protected mode, registering a checksum of the process that issued the command to open the file.

3. The method of claim 1, wherein the file is of a key file type.

4. The method of claim 3, wherein the key file type includes a file type for a program that works as an add-on to another program.

5. The method of claim 3, wherein the key file type includes a file type for a file management applications.

6. The method of claim 3, wherein the key file type includes a file type associated with a layered service provider.

7. The method of claim 3, wherein the key file type includes a file type associated with system drivers.

8. A computer system comprising:
a processor;
an operating system, wherein the operating system contains a registry having file associations;
a user account module;
a dynamic rights assignment module configured to;
evaluate what process issued a command to open a file, wherein the command to open the file triggered the registry to call the dynamic rights assignment module;
determine if the process that issued the command to open the file is known to be safe;
when it is determined that the process that issued the command to open the file is not known to be safe, prompting a user whether to run in protected mode; and
when the user indicates that protected mode should be run, issuing a call to the user account module to create a temporary user to run a program associated with a file association for the file.

9. The computer system of claim 8, wherein the dynamic rights assignment module is further configured to:
prompt the user as to whether to run the command one time or forever using the protected mode; and
when the user indicates that the command should be run forever using the protected mode, register a checksum of the process that issued the command to open the file.

10. A program storage device readable by a machine tangibly embodying a program of instructions executable by the machine to perform a method for blocking malicious software in an operating system, the method comprising:
receiving a command to open a file;
determining a file association for the file, wherein the file association points to a dynamic rights assignment module;
evaluating what process issued the command to open the file;
determining if the process that issued the command to open the file is known to be safe;
when it is determined that the process that issued the command to open the file is not known to be safe, prompting a user whether to run in protected mode;
when the user indicates that protected mode should be run, creating a temporary user of the operating system; and
running a program associated with the file association for the file, as the temporary user.
